(19) United States
(12) Patent Application Publication
(10) Pub. No.: US 2025/0150226 A1
(43) Pub. Date: May 8, 2025

(54) SEARCH SPACE SET CONFIGURATION FOR A PAIR OF DOWNLINK AND UPLINK CELLS

(71) Applicant: QUALCOMM Incorporated, San Diego, CA (US)

(72) Inventors: Kazuki TAKEDA, Minato-ku (JP); Peter GAAL, San Diego, CA (US); Mostafa KHOSHNEVISAN, San Diego, CA (US)

(21) Appl. No.: 18/501,385

(22) Filed: Nov. 3, 2023

(51) Int. Cl. H04L 5/00; H04W 76/15

(52) U.S. Cl. CPC H04L 5/0048; H04W 76/15

(57) ABSTRACT

Methods, systems, and devices for wireless communications are described. A user equipment (UE) may receive an indication of search space set parameters for a first cell associated with an uplink carrier and a second cell associated with a downlink carrier, the first cell comprising an uplink-only cell and the second cell comprising a downlink-only cell. The UE may receive a grant scheduling an uplink transmission via the first cell using the uplink carrier, a downlink transmission via the second cell using the downlink carrier, or both, the grant received according to the search space set parameters and via the downlink carrier of the second cell or a second downlink carrier associated with a third cell. The UE may perform the uplink transmission, receive the downlink transmission, or both, according to the grant.

### FIELD OF TECHNOLOGY

The present disclosure relates to wireless communications, including search space set configuration for a pair of downlink and uplink cells.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support search space (SS) set configuration for a pair of downlink and uplink cells. For example, the described techniques provide for diverse mechanisms to conserve resources when a user equipment (UE) is configured with a pair of uplink-only and downlink-only cells. The UE may receive an indication of parameters for a SS set for a first cell having an uplink carrier (an uplink-only cell without a downlink carrier) and a second cell having a downlink carrier (a downlink-only cell without an uplink carrier). The SS set parameters may be a common or shared SS set in that the same SS set is monitored by the UE for grant(s) for the configured cell(s). The UE may receive a grant scheduling an uplink transmission to the first cell (the uplink-only cell) or a downlink transmission from the second cell (the downlink-only cell) using the common or shared SS set. The UE may perform the uplink transmission or receive the downlink transmission according to the grant.

A method for wireless communications by a UE is described. The method may include receiving an indication of SS set parameters for a first cell associated with an uplink carrier and a second cell associated with a downlink carrier, the first cell including an uplink-only cell and the second cell including a downlink-only cell, receiving a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell, and performing the uplink transmission, receiving the downlink transmission, or both, according to the grant.

A UE for wireless communications is described. The UE may include one or more memories storing processor executable code, and one or more processors coupled with the one or more memories. The one or more processors may individually or collectively operable to execute the code to cause the UE to receive an indication of SS set parameters for a first cell associated with an uplink carrier and a second cell associated with a downlink carrier, the first cell including an uplink-only cell and the second cell including a downlink-only cell, receive a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell, and perform the uplink transmission, receiving the downlink transmission, or both, according to the grant.

Another UE for wireless communications is described. The UE may include means for receiving an indication of SS set parameters for a first cell associated with an uplink carrier and a second cell associated with a downlink carrier, the first cell including an uplink-only cell and the second cell including a downlink-only cell, means for receiving a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell, and means for performing the uplink transmission, receiving the downlink transmission, or both, according to the grant.

A non-transitory computer-readable medium storing code for wireless communications is described. The code may include instructions executable by a processor to receive an indication of SS set parameters for a first cell associated with an uplink carrier and a second cell associated with a downlink carrier, the first cell including an uplink-only cell and the second cell including a downlink-only cell, receive a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell, and perform the uplink transmission, receiving the downlink transmission, or both, according to the grant.

Some examples of the method, user equipment (UEs), and non-transitory computer-readable medium described herein may further include operations, features, means, or instructions for receiving information identifying the first cell and the second cell as a paired set of cells, where the SS set parameters may be based on the paired set of cells.

In some examples of the method, user equipment (UEs), and non-transitory computer-readable medium described herein, receiving the grant may include operations, features, means, or instructions for receiving a shared carrier indicator field (CIF) of the grant that may be associated with the first cell and the second cell, where the shared CIF indicates that the grant schedules the uplink transmission via the first cell, the downlink transmission via the second cell, or both.

In some examples of the method, user equipment (UEs), and non-transitory computer-readable medium described herein, receiving the grant may include operations, features, means, or instructions for receiving a first grant scheduling the uplink transmission via the first cell and receiving a second grant scheduling the downlink transmission via the second cell, where a first number of information bits in the first grant and a second number of information bits in the second grant include a same number of information bits.

Some examples of the method, user equipment (UEs), and non-transitory computer-readable medium described herein may further include operations, features, means, or instructions for receiving an indication of an information bit size allocation for scheduling the uplink transmission via the first cell and for scheduling the downlink transmission via the second cell, where the same number of information bits may be based on the information bit size allocation.

In some examples of the method, user equipment (UEs), and non-transitory computer-readable medium described herein, receiving the grant may include operations, features, means, or instructions for receiving an indication of whether the grant schedules the uplink transmission via the first cell or the downlink transmission via the second cell.

In some examples of the method, user equipment (UEs), and non-transitory computer-readable medium described herein, receiving the grant may include operations, features, means, or instructions for monitoring, according to the SS set parameters, a SS set on the downlink carrier of the second cell, the second downlink carrier of the third cell, or both.

In some examples of the method, user equipment (UEs), and non-transitory computer-readable medium described herein, the SS set parameters identify a set of control channel resources to monitor to receive the grant on the downlink carrier of the second cell or the second downlink carrier of the third cell.

In some examples of the method, user equipment (UEs), and non-transitory computer-readable medium described herein, the grant includes a downlink control information (DCI) format 0_2 uplink grant, a DCI format 1_2 downlink grant, or both.

In some examples of the method, user equipment (UEs), and non-transitory computer-readable medium described herein, the first cell includes a non-downlink carrier cell and the second cell includes a non-uplink carrier cell.

A method for wireless communications by a network entity is described. The method may include transmitting, to a UE, an indication of SS set parameters for a first cell associated with an uplink carrier and a second cell associated with a downlink carrier, the first cell including an uplink-only cell and the second cell including a downlink-only cell, transmitting a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell, and receiving the uplink transmission from the UE, performing the downlink transmission to the UE, or both, according to the grant.

A network entity for wireless communications is described. The network entity may include one or more memories storing processor executable code, and one or more processors coupled with the one or more memories. The one or more processors may individually or collectively operable to execute the code to cause the network entity to transmit, to a UE, an indication of SS set parameters for a first cell associated with an uplink carrier and a second cell associated with a downlink carrier, the first cell including an uplink-only cell and the second cell including a downlink-only cell, transmit a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell, and receive the uplink transmission from the UE, performing the downlink transmission to the UE, or both, according to the grant.

Another network entity for wireless communications is described. The network entity may include means for transmitting, to a UE, an indication of SS set parameters for a first cell associated with an uplink carrier and a second cell associated with a downlink carrier, the first cell including an uplink-only cell and the second cell including a downlink-only cell, means for transmitting a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell, and means for receiving the uplink transmission from the UE, performing the downlink transmission to the UE, or both, according to the grant.

A non-transitory computer-readable medium storing code for wireless communications is described. The code may include instructions executable by a processor to transmit, to a UE, an indication of SS set parameters for a first cell associated with an uplink carrier and a second cell associated with a downlink carrier, the first cell including an uplink-only cell and the second cell including a downlink-only cell, transmit a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell, and receive the uplink transmission from the UE, performing the downlink transmission to the UE, or both, according to the grant.

Some examples of the method, network entities, and non-transitory computer-readable medium described herein may further include operations, features, means, or instructions for transmitting information identifying the first cell and the second cell as a paired set of cells, where the SS set parameters may be based on the paired set of cells.

In some examples of the method, network entities, and non-transitory computer-readable medium described herein, transmitting the grant may include operations, features, means, or instructions for configuring the grant to indicate a shared CIF that may be associated with the first cell and the second cell, where the shared CIF indicates that the grant schedules the uplink transmission via the first cell, the downlink transmission via the second cell, or both.

In some examples of the method, network entities, and non-transitory computer-readable medium described herein, transmitting the grant may include operations, features, means, or instructions for transmitting a first grant scheduling the uplink transmission via the first cell and transmitting a second grant scheduling the downlink transmission via the second cell, where a first number of information bits in the first grant and a second number of information bits in the second grant include a same number of information bits.

Some examples of the method, network entities, and non-transitory computer-readable medium described herein may further include operations, features, means, or instructions for transmitting an indication of an information bit size allocation for scheduling the uplink transmission via the first cell and for scheduling the downlink transmission via the second cell, where the same number of information bits may be based on the information bit size allocation.

In some examples of the method, network entities, and non-transitory computer-readable medium described herein, transmitting the grant may include operations, features, means, or instructions for configuring an indication of whether the grant schedules the uplink transmission via the first cell or the downlink transmission via the second cell.

In some examples of the method, network entities, and non-transitory computer-readable medium described herein, transmitting the grant may include operations, features, means, or instructions for transmitting, according to the SS set parameters, the grant on a SS set on the downlink carrier of the second cell, the second downlink carrier of the third cell, or both.

In some examples of the method, network entities, and non-transitory computer-readable medium described herein, the SS set parameters identify a set of control channel resources to monitor to receive the grant on the downlink carrier of the second cell or the second downlink carrier of the third cell.

In some examples of the method, network entities, and non-transitory computer-readable medium described herein, the grant includes a DCI format 0_2 uplink grant, a DCI format 1_2 downlink grant, or both.

In some examples of the method, network entities, and non-transitory computer-readable medium described herein, the first cell includes a non-downlink carrier cell and the second cell includes a non-uplink carrier cell.

### BRIEF DESCRIPTION OF THE DRAWINGS

FIG. 1 shows an example of a wireless communications system that supports search space (SS) set configuration for a pair of downlink and uplink cells in accordance with one or more aspects of the present disclosure.

FIG. 2 shows an example of a wireless communications system that supports SS set configuration for a pair of downlink and uplink cells in accordance with one or more aspects of the present disclosure.

FIG. 3 shows an example of a wireless communications system that supports SS set configuration for a pair of downlink and uplink cells in accordance with one or more aspects of the present disclosure.

FIG. 4 shows an example of a bit size scheme that supports SS set configuration for a pair of downlink and uplink cells in accordance with one or more aspects of the present disclosure.

FIGS. 5 and 6 show block diagrams of devices that support SS set configuration for a pair of downlink and uplink cells in accordance with one or more aspects of the present disclosure.

FIG. 7 shows a block diagram of a communications manager that supports SS set configuration for a pair of downlink and uplink cells in accordance with one or more aspects of the present disclosure.

FIG. 8 shows a diagram of a system including a device that supports SS set configuration for a pair of downlink and uplink cells in accordance with one or more aspects of the present disclosure.

FIGS. 9 and 10 show block diagrams of devices that support SS set configuration for a pair of downlink and uplink cells in accordance with one or more aspects of the present disclosure.

FIG. 11 shows a block diagram of a communications manager that supports SS set configuration for a pair of downlink and uplink cells in accordance with one or more aspects of the present disclosure.

FIG. 12 shows a diagram of a system including a device that supports SS set configuration for a pair of downlink and uplink cells in accordance with one or more aspects of the present disclosure.

FIGS. 13 through 17 show flowcharts illustrating methods that support SS set configuration for a pair of downlink and uplink cells in accordance with one or more aspects of the present disclosure.

### DETAILED DESCRIPTION

Wireless networks may support a downlink-only cell being configured for a user equipment (UE), such as to be used for downlink carrier aggregation communications with the UE. The UE may be configured with an uplink-only cell, such as to be used for uplink carrier aggregation with the UE. For example, the UE may be configured with a primary cell having both uplink and downlink carriers, the downlink-only cell, or the uplink-only cell by the network. Such networks may support cross-carrier scheduling where the primary cell or the downlink-only cell transmits a grant scheduling uplink transmissions via the primary cell or the uplink-only cell or scheduling downlink transmissions via the primary cell or the downlink-only cell. However, such techniques are inefficient because such grants separately schedule communications on a per-cell basis.

The described techniques provide for diverse mechanisms to conserve resources when a UE is configured with a pair of uplink-only and downlink-only cells. The UE may receive an indication of parameters for a search space (SS) set for a first cell having an uplink carrier (an uplink-only cell without a downlink carrier) and a second cell having a downlink carrier (a downlink-only cell without an uplink carrier). The SS set parameters may be a common or shared SS set in that the same SS set is monitored by the UE for grant(s) for the configured cell(s). The UE may receive a grant scheduling an uplink transmission to the first cell (the uplink-only cell) or a downlink transmission from the second cell (the downlink-only cell) using the common or shared SS set. The UE may perform the uplink transmission or receive the downlink transmission according to the grant.

Aspects of the disclosure are initially described in the context of wireless communications systems. Aspects of the disclosure are further illustrated by and described with reference to apparatus diagrams, system diagrams, and flowcharts that relate to SS set configuration for a pair of downlink and uplink cells.

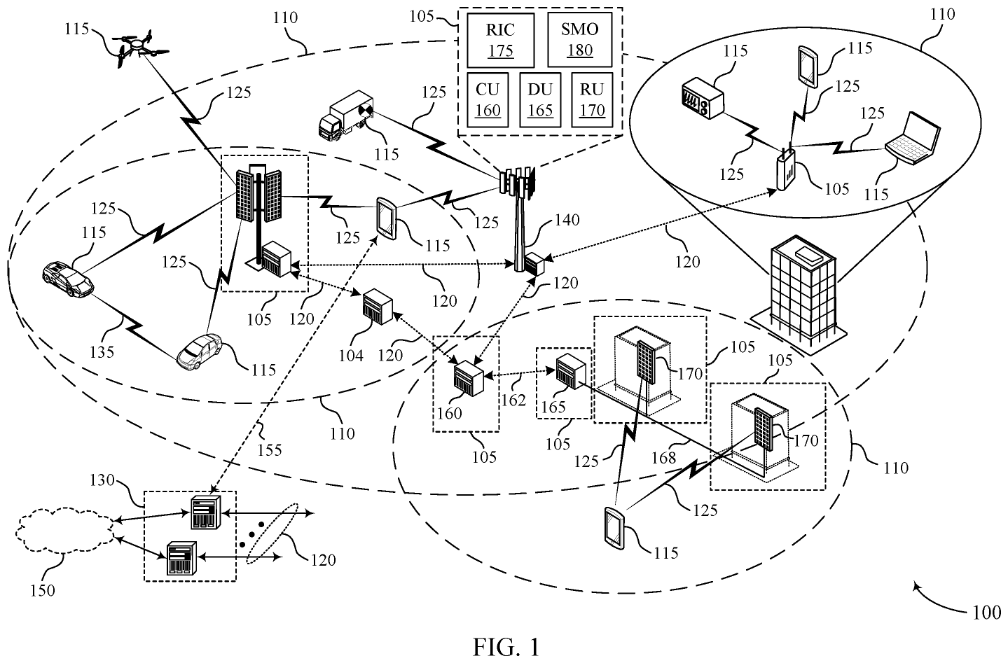

FIG. 1 shows an example of a wireless communications system 100 that supports SS set configuration for a pair of downlink and uplink cells in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support SS set configuration for a pair of downlink and uplink cells as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(λfₘₐₓ·N_{f}) seconds, for which/Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more SS sets, and each SS set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. SS sets may include common SS sets configured for sending control information to multiple UEs 115 and UE-specific SS sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive an indication of SS set parameters for a first cell associated with an uplink carrier and a second cell associated with a downlink carrier, the first cell comprising an uplink-only cell and the second cell comprising a downlink-only cell. The UE 115 may receive a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell. The UE 115 may perform the uplink transmission, receive the downlink transmission, or both, according to the grant.

A network entity 105 may transmit, to a UE 115, an indication of SS set parameters for a first cell associated with an uplink carrier and a second cell associated with a downlink carrier, the first cell comprising an uplink-only cell and the second cell comprising a downlink-only cell. The network entity 105 may transmit a grant scheduling an uplink transmission via the first cell using the uplink carrier, a downlink transmission via the second cell using the downlink carrier, or both, for the UE 115, the grant transmitted according to the SS set parameters and via the downlink carrier of the second cell or a second downlink carrier associated with a third cell. The network entity 105 may receive the uplink transmission from the UE 115, perform the downlink transmission to the UE 115, or both, according to the grant.

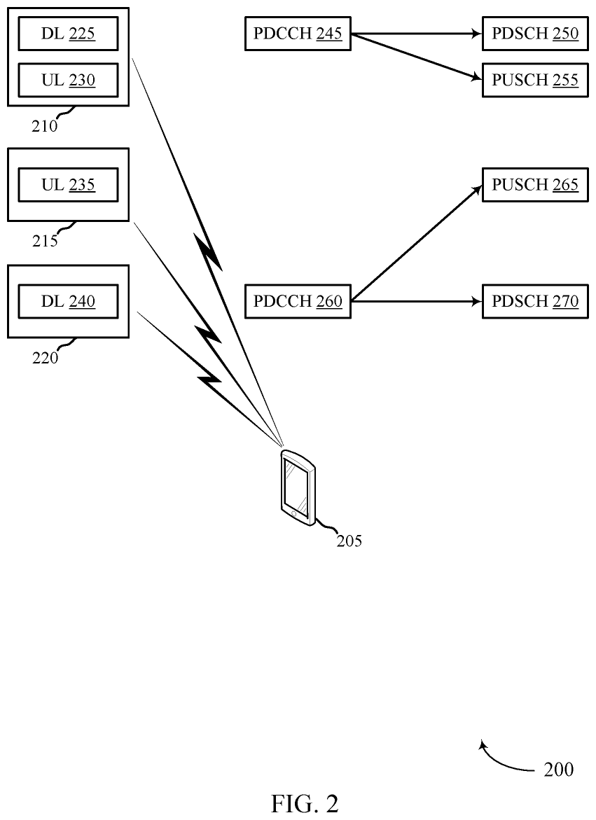

FIG. 2 shows an example of a wireless communications system 200 that supports SS set configuration for a pair of downlink and uplink cells in accordance with one or more aspects of the present disclosure. Wireless communications system 200 may implement aspects of wireless communications system 100. Wireless communications system 200 may include a UE 205, a network entity 210, a network entity 215, and a network entity 220, which may be examples of the corresponding devices described herein.

For example, the network entity 210 may be an example of a PCell, SPCell, or an SCell that is associated with an uplink carrier 230 and a downlink carrier 225. The network entity 215 may be an example of a first cell (e.g., an SCell) that is associated with an uplink carrier 235 (e.g., the first cell may be an uplink-only cell that does not have a downlink carrier). The network entity 220 may be an example of a second cell (e.g., an SCell) that is associated with a downlink carrier 240 (e.g., the second cell may be a downlink-only cell that does not have an uplink carrier).

That is, the network entity 210 may be a primary serving cell of the UE 205. This may include the network entity 210 scheduling communications with the UE 205, such as downlink communications using the downlink carrier 225 or uplink communications using the uplink carrier 230. The network entity 215 (the first cell) and the network entity 220 (the second cell) may be a pair of cells associated with the UE 205, where each cell has either an uplink carrier and no downlink carrier or a downlink carrier and no uplink carrier. The UE 205 may be scheduled to perform uplink transmission(s) to the network entity 215 via the uplink carrier 235 or to receive downlink transmission(s) from the network entity 220 via the downlink carrier 240. The network entity 215 may be an example of a secondary uplink carrier (SUL) cell or an example of an enhanced SUL (eSUL) cell configured for uplink transmissions from the UE 205. The network entity 220 may be an example of a secondary downlink (SDL) cell or an example of an enhanced SDL (eSDL).

For example, when operating in a connected mode the eSUL may be configured as an uplink-only cell used for uplink CA with cell(s) that do not have corresponding downlink carrier(s) in the cell. The uplink-only cell(s) may be scheduled by PDCCH in other cell(s) that have downlink carriers. In some examples, this may include cross-carrier/multi-carrier scheduling occurring between the different cells. For example, wireless communications system 200 illustrates a non-limiting example of where the network entity 210 schedules uplink or downlink communications using its associated uplink carrier 230 or downlink carrier 225, respectively, with the network entity 220 scheduling uplink transmissions to the network entity 215 via the uplink carrier 235 or downlink transmissions from the network entity 220 via the downlink carrier 240. Wireless communications system 300 illustrates a non-limiting example of the PCell (e.g., the network entity 210) scheduling uplink or downlink communications for the PCell, the uplink-only cell(s), or the downlink-only cell(s).

When operating in an idle mode, the eSUL may be used to initial channel access (e.g., random access), such as using a system information block (SIB) on the downlink cell carrying configuration information for the uplink/eSUL for the random-access procedure.

The UE 205 may generally monitor a SS set to detect a grant (e.g., PDCCH) scheduling communications for the UE 205. For example, the SS set parameters may define the time resources, frequency resources, spatial resources, or code resources that the UE 205 is to monitor to detect a PDCCH transmission from a cell having a downlink carrier. For example, the SS set may define a set of contiguous control channel elements (CCEs)/resource element groups (REGs) that the UE 205 is to monitor for scheduling assignments/grants relating to a CC. As discussed above, SS sets may be common SS sets or UE-specific SS sets. The SS sets may define control channel resources that the UE 205 is to monitor to receive PDCCH grants.

Some wireless networks allocate or otherwise configure a SS set for a UE for a given cell (e.g., on a per-serving cell basis for the UE 205). Single SS set configurations enable PDCCH monitoring for both downlink and uplink downlink control information (DCI) formats for the serving cell. For the PCell, a primary secondary cell (PSCell), or a SCell that have both uplink and downlink carriers (e.g., the network entity 210), this enables the network to configure the UE 205 to monitor PDCCH candidates (e.g., over resources of the SS set) for DCI formats for downlink scheduling and for uplink scheduling. For SCell(s) that have only downlink carriers (e.g., for downlink CA without uplink CA), the UE 205 may not monitor for uplink DCI formats in the SS set configuration of the downlink-only cell. That is, some wireless networks may not support uplink scheduling in a downlink-only SCell.

These networks may enable downlink-only cells (e.g., the network entity 220) being configured for the UE 205 as a SCell, with the downlink-only cells supporting downlink CA techniques. The uplink-only cells may be configured for the UE 205 as a SCell, with the uplink-only cells supporting uplink CA techniques.

However, some wireless networks may be inefficient in that unnecessary configurations and PDCCH monitoring may be performed. That is, the SS set configuration (e.g., the parameters for the SS set) as well as the carrier indicator field (CIF) for cross-carrier scheduling that is carried in the PDCCH grant are generally configured on a per-cell basis for the UE 205. For example, in some networks the UE 205 may be configured with a first SS set for the network entity 210 and a second SS set for the network entity 220. The UE 205 may monitor for grants from each configured cell (e.g., monitor the SS set resources) according to the SS set configured for the respective cell. In some examples, additional SS set configurations are configured for the UE 205 to monitor for grants scheduling uplink transmissions to the network entity 215 (e.g., from a third cell).

Accordingly, in some networks separate SS set configurations and CIF values are used even for downlink-only cell(s) and uplink-only cell(s). Therefore, if the UE 205 is configured with CA with cells #1, #2, #3, where cell #1 has both downlink and uplink, cell #2 has only uplink, and cell #3 has only downlink, this may result in the UE 205 being configured with three different SS set configurations and three different CIF values. The UE 205 may monitor PDCCH candidates for three different serving cells on different SS sets. Moreover, the UE 205 may process a number of DCI formats for each of the three serving cells (e.g., the UE 205 may be able to process three times the maximum number of DCI format sizes the UE 205 can process per cell). Furthermore, if the UE 205 reports a limited PDCCH blind decoding (BD)/CCE capability (e.g., via a pdcch-BlindDetectionCA parameter), the limited number of PDCCH BDs/CCEs may be shared across SS sets for the three different serving cells.

Accordingly, aspects of the techniques described herein provide for a SS set configuration for a pair of downlink-only and uplink-only cells. Aspects of the techniques described herein provide for the pair of downlink-only and uplink-only cells to share a single SS set configuration (e.g., a shared SS set) for the two cells. In some examples, the pair of cells may be treated as a paired spectrum or as if it is a FDD cell.

For example, the UE 205 may receive or otherwise obtain an indication of SS set parameters for a PCell (e.g., the network entity 210) that is associated with both the uplink carrier 230 and the downlink carrier 225. The SS set parameters may identify the resources that the UE 205 is to monitor to receive a grant from the PCell. For example, the UE 205 may receive or otherwise obtain a grant (e.g., a PDCCH 245) via the downlink carrier 225 of the network entity 210. The grant may schedule a downlink transmission (e.g., the PDSCH 250) from the network entity 210 to the UE 205 via the downlink carrier 225 or may schedule an uplink transmission (e.g., the PUSCH 255) from the UE 205 to the network entity 210 via the uplink carrier 230. The SS set for the PCell/PSCell or for a SCell having both uplink and downlink carriers may be a common SS set or a UE-specific SS set.

The UE 205 may also receive or otherwise obtain an indication of SS set parameters for a first cell having or otherwise associated with an uplink carrier (e.g., the network entity 215 having the uplink carrier 235) and a second cell having or otherwise associated with a downlink carrier (e.g., the network entity 220 having the downlink carrier 240). The first cell may be an uplink-only cell in that the network entity 215 does not have a downlink carrier. The second cell may be a downlink-only cell in that the network entity 220 does not have an uplink carrier. The SS set parameters may be shared SS resources that the UE 205 is to monitor to receive grants scheduling uplink transmissions to the first cell or scheduling downlink transmissions from the second cell.

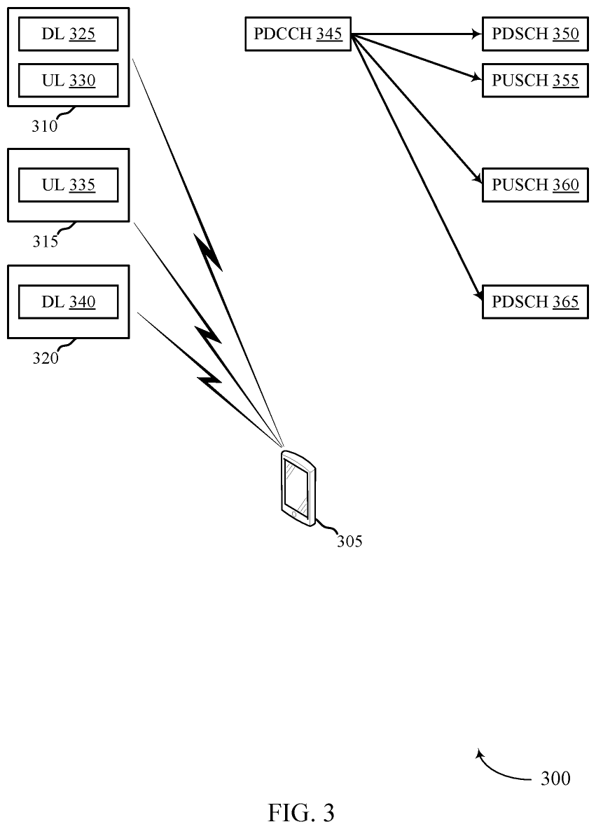

The UE 205 may also receive or otherwise obtain a grant (e.g., the PDCCH 260) scheduling an uplink transmission (e.g., PUSCH 265) via the first cell (e.g., an uplink transmission to the network entity 215) or scheduling a downlink transmission (e.g., PDSCH 270) via the second cell (e.g., a downlink transmission from the network entity 220). The grant may be received according to the SS set parameters. For example, the grant may be received based on the UE 205 monitoring a SS set. For example, the SS set parameters may identify or otherwise indicate a set of control channel resources (e.g., PDCCH resources) to monitor to receive the grant. The grant may be received from the second cell using the downlink carrier 240 or from a second downlink carrier associated with a third cell (such as the downlink carrier 225 of the PCell of the UE, as shown in FIG. 3). The grant may be a DCI format 0_2 uplink grant or may be a DCI format 1_2 downlink grant. The UE 205 may perform the uplink transmission to the first cell (e.g., the UE 205 may perform the PUSCH 265 transmission on the uplink carrier 235) or receive the downlink transmission from the second cell (e.g., the UE 205 may receive the PDSCH 270 on the downlink carrier 240) according to the grant.

Accordingly, wireless communications system 200 illustrates a non-limiting example of a SS set configuration being provided for a pair of cells consisting of an uplink-only cell (a cell not having a downlink carrier) and a downlink-only cell (a cell not having an uplink carrier). The shared SS set configuration (e.g., the parameters for the SS set) may be based on the cells being paired (e.g., to be treated as a paired spectrum or as an FDD cell). In some examples, the UE 205 may be configured with or otherwise receive information identifying the pair of cells (e.g., the paired uplink-only cell and downlink-only cell). For example, the UE 205 may receive the information identifying the first cell and the second cell as a paired set of cells. The SS set parameters may be configured or the paired cells. For example, an RRC parameter may be indicted that identifies to the UE 205 which pair of downlink-only and uplink-only cells are associated with each other.

In some examples, a shared CIF value may be used for grant(s) scheduling communications via the paired set of cells. For example, aspects of the techniques described herein may use the same CIF value for scheduling grants received via the SS set. That is, if the same value of CIF is configured for the downlink-only cell and the uplink-only cell that are scheduled by the same cell, the paired set of cells may be considered as a pair of cells that share the SS set configuration and CIF value. The same CIF value being configured for different scheduled cells from the same scheduling cell if the scheduled cells are a pair of a downlink-only cell and an uplink-only cell. Accordingly, in some examples, the UE 205 may receive a CIF in the grant that is associated with both the first cell and the second cell. The shared CIF (e.g., the same CIF value) may indicate that the grant schedules the uplink transmission to the first cell, the downlink transmission from the second cell, or both. Additionally, or alternatively, aspects of the techniques described herein may not use the CIF field for scheduling grants received via the SS set. That is, if the UE is configured with the downlink-only cell and the uplink-only cell that are scheduled by the same cell, and if there is no other cell that is scheduled by the same cell, the paired set of cells may be considered as a pair of cells that share the SS set configuration without CIF field. Accordingly, in some examples, the UE 205 may receive a grant without CIF field that is associated with both the first cell and the second cell.

In some examples, a bit used for an identifier for DCI formats may be used to indicate whether the grant schedules the uplink transmission or the downlink transmission. For example, each DCI format may include a one-bit identifier for DCI formats. This identifier may be used, according to the techniques described herein, to indicate whether the DCI format is for downlink scheduling on the downlink-only cell or for uplink scheduling on the uplink-only cell for a given pair of uplink-only and downlink-only cells. For example, the value of the bit may be set to “0” to indicate an uplink DCI format or to “1” to indicate a downlink DCI format, or vice versa. Accordingly, the UE 205 may receive an indication of whether the grant schedules the uplink transmission or schedules the downlink transmission. The indication may be provided via the identifier for the DCI format.

Accordingly, wireless communications system 200 illustrates a non-limiting example of pairing a downlink-only cell and an uplink-only cell for SS set configurations. This may reduce the number of cells (e.g., SS sets) that the UE 205 has to monitor (e.g., from three cells to two cells, in this non-limiting example). This may reduce UE complexity regarding PDCCH monitoring (e.g., based on the UE 205 monitoring fewer SS sets). The techniques described herein may further increase PDCCH scheduling flexibility for the network.

FIG. 3 shows an example of a wireless communications system 300 that supports SS set configuration for a pair of downlink and uplink cells in accordance with one or more aspects of the present disclosure. Wireless communications system 300 may implement aspects of wireless communications system 100 or wireless communications system 200. Wireless communications system 300 may include a UE 305, a network entity 310, a network entity 315, and a network entity 320, which may be examples of the corresponding devices described herein.

For example, the network entity 310 may be an example of a PCell, an PSCell, or an SCell that is associated with an uplink carrier 330 and a downlink carrier 325. The network entity 315 may be an example of a first cell (e.g., an SCell) that is associated with an uplink carrier 335 (e.g., the first cell may be an uplink-only cell that does not have a downlink carrier). The network entity 320 may be an example of a second cell (e.g., an SCell) that is associated with a downlink carrier 340 (e.g., the second cell may be a downlink-only cell that does not have an uplink carrier).

As discussed above, wireless communications system 300 illustrates a non-limiting example of the PCell (e.g., the network entity 310) scheduling uplink or downlink communications for the PCell, the uplink-only cell(s), or the downlink-only cell(s). For example, aspects of the techniques described herein provide for a SS set configuration for a pair of downlink-only and uplink-only cells. The techniques described herein provide for the pair of downlink-only and uplink-only cells to share a single SS set configuration (e.g., a shared SS set) for the two cells. In some examples, the pair of cells may be treated as a paired spectrum or as if it is a FDD cell. In the non-limiting example shown in FIG. 3, the SS set for the set of paired cells may use the same control channel resources as the SS set for the PCell. Instead, the CIF value may be used to indicate whether the grant schedules uplink or downlink communications via the PCell or schedules uplink or downlink communications via the set of paired uplink-only and downlink-only cells.

For example, the UE 305 may receive or otherwise obtain an indication of SS set parameters for a PCell (e.g., the network entity 310) that is associated with both the uplink carrier 330 and the downlink carrier 325. However, the SS set may also be for grants scheduling communications via the first cell (e.g., the uplink-only cell, such as the network entity 315) or the second cell (e.g., the downlink-only cell, such as the network entity 320). The SS set parameters may identify the resources that the UE 305 is to monitor to receive a grant from the PCell scheduling PCell communications or scheduling paired-cell communications. For example, the UE 305 may receive or otherwise obtain a grant (e.g., a PDCCH 345) via the downlink carrier 325 of the network entity 310. In this example, this may include the UE 305 receiving the grant on a second downlink carrier associated with a third cell (the third cell referring to the network entity 310, in this example). The grant may schedule a downlink transmission (e.g., the PDSCH 350) from the network entity 310 to the UE 305 via the downlink carrier 325 or may schedule an uplink transmission (e.g., the PUSCH 355) from the UE 305 to the network entity 310 via the uplink carrier 330.

In some examples, the grant may schedule an uplink transmission (e.g., PUSCH 360) via the first cell (e.g., an uplink transmission to the network entity 315) or schedule a downlink transmission (e.g., PDSCH 365) via the second cell (e.g., a downlink transmission from the network entity 320). The grant may be received according to the SS set parameters.

In some examples, a shared CIF value may be used for grant(s) scheduling communications via the paired set of cells. For example, aspects of the techniques described herein may use the CIF value indicated in the grant to identify or otherwise indicate whether the grant is scheduling communications via the PCell or is scheduling communications via the first or second cells (e.g., the set of paired uplink-only and downlink-only cells). For example, the CIF value indicated in PDCCH 345 may be set to “0” to indicate that the grant is scheduling communications between the UE 305 and the network entity 310 via the downlink carrier 325 or uplink carrier 330 or be set to “1” to indicate that the grant is scheduling an uplink transmission to the network entity 315 via the uplink carrier 335 or a downlink transmission from the network entity 320 via the downlink carrier 340, or vice versa. Accordingly, the UE 305 may detect the CIF value indicated in the grant and use this to identify or otherwise determine whether the grant is scheduling communications with the PCell (e.g., PCell, PSCell, or SCell having both uplink and downlink carriers) or is scheduling communications with the set of paired uplink-only and downlink-only cells (e.g., the network entity 315 or the network entity 320).

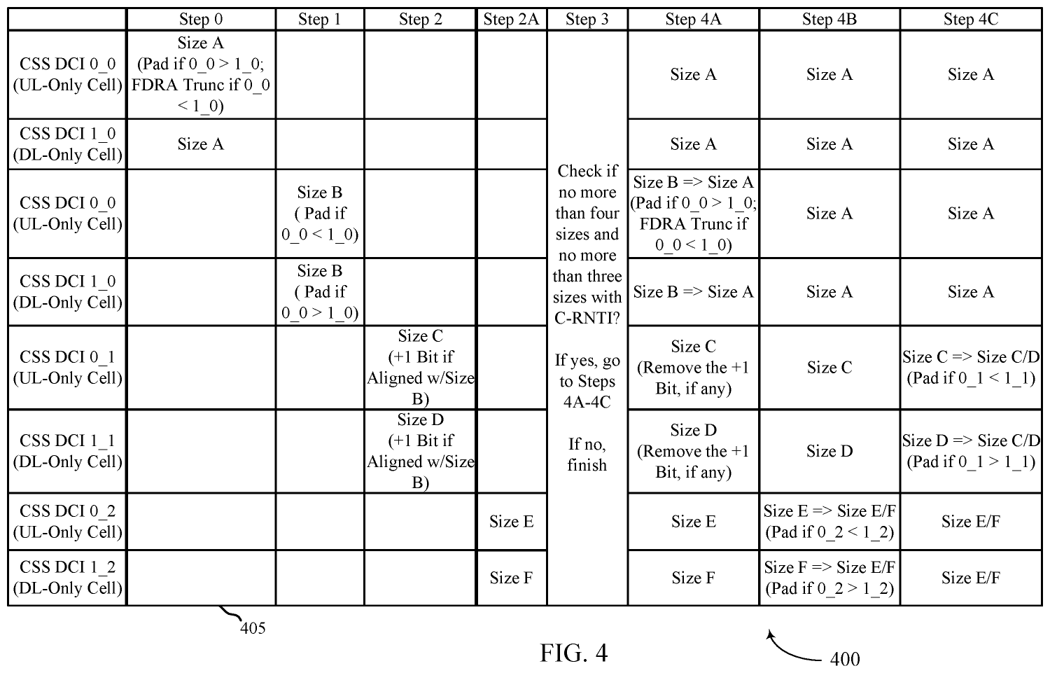

FIG. 4 shows an example of a bit size scheme 400 that supports SS set configuration for a pair of downlink and uplink cells in accordance with one or more aspects of the present disclosure. Bit size scheme 400 may implement aspects of wireless communications systems 100, 200, or 300. Aspects of bit size scheme 400 may be implemented at or implemented by a UE or a network entity, which may be examples of the corresponding devices described herein.

As discussed above, aspects of the techniques described herein provide for a SS set to be configured that is shared between a set of paired uplink-only and downlink-only cells. For example, a UE may receive an indication of SS set parameters for a first cell (the uplink-only cell) and a second cell (the downlink-only cell). The first cell may have an uplink carrier, but not a downlink carrier. The second cell may have a downlink carrier, but not an uplink carrier. The first and second cells may be paired cells in that the cells may be treated or considered as a paired spectrum or as an FDD cell for scheduling purposes. The UE may monitor the control channel resources (e.g., PDCCH resources) according to the SS set parameters to receive a grant. The grant may schedule an uplink transmission via the first cell using the uplink carrier or a downlink transmission via the second cell using the downlink carrier. The grant may be received via the downlink carrier of the second cell or via a second downlink carrier of a third cell. For example, the SS set parameters may identify control channel resources for the downlink carrier of the second cell or the SS set parameters may identify control channel resources for the downlink carrier of the PCell/PSCell. The UE may perform the uplink transmission to the first cell using the uplink carrier or receive the downlink transmission from the second cell according to the grant.

Thus, in some examples the SS set parameters may be used for an uplink grant (e.g., a first grant) scheduling an uplink transmission to the first cell via the uplink carrier or for a downlink grant (e.g., a second grant) scheduling a downlink transmission from the second cell via the downlink carrier. In some examples, the uplink grant and the downlink grant may be size aligned (e.g., based on the number of information bits). That is, in some examples a DCI size alignment procedure may be running that assumes that the downlink DCI (e.g., the second grant) and the uplink DCI (e.g., the first grant) for the pair of downlink-only and uplink-only cells from the same scheduling cell are size aligned (e.g., treated as if the grants are for a downlink carrier and an uplink carrier of the same serving cell).

For example, the scheduling cell or the UE may receive or otherwise determine an indication of an information bit size allocation (e.g., a DCI size budget) to be used for scheduling the uplink transmission and the downlink transmission. The DCI size budget may define that the same number of information bits are used for the first grant and the second grant. Aligning the number of information bits in the first and second grants may be based on the DCI size budget (e.g., when necessary).

Bit size scheme 400 illustrates a non-limiting example of an information bit size scheme 405 that may be used for the first grant scheduling the uplink communications and the second grant scheduling the downlink communications for the set of paired uplink-only and downlink-only cells. The information bit size scheme 405 illustrates an example where a DCI format 0_0 used to schedule an uplink transmission to the first cell and a DCI format 1_0 used to schedule a downlink transmission from the second cell may be size aligned, when necessary, to meet the DCI size budget. The information bit size scheme 405 illustrates an example where a DCI format 0_1 used to schedule an uplink transmission to the first cell and a DCI format 1_1 used to schedule a downlink transmission from the second cell may be size aligned, when necessary, to meet the DCI size budget. The information bit size scheme 405 illustrates an example where a DCI format 0_2 used to schedule an uplink transmission to the first cell and a DCI format 1_2 used to schedule a downlink transmission from the second cell may be size aligned, when necessary, to meet the DCI size budget. That is, the number of information bits in the first grant may be the same number of information bits in the second grant according to the information bit size allocation.

In particular, the information bit size scheme 405 illustrates non-limiting steps to align the sizes of the first grant and the second grant to include the same number of information bits. Padding and truncation may be applied to the DCI formats according to the steps executed in the order shown (e.g., steps 0-4).

For example, at step 0 the network entity or UE may determine the size (e.g., the number of information bits to be used) for DCI format 0_0 to be used for scheduling an uplink transmission to the first cell from the UE. The size of the DCI (e.g., the number of information bits) may be based on a number of fixed bit sizes (e.g., a known number of bits corresponding to a time domain resources assignment, MCS, and other parameters) as well as a variable number of information bits used to indicate other parameters (such as a frequency domain resource assignment). For reference, the size of the DCI format 0_0 may be set to A (e.g., A information bits are included in the DCI format 0_0 scheduling an uplink transmission on the uplink carrier of the uplink-only cell). The network entity or UE may identify or otherwise determine that the number of information bits included in the DCI format 1_0 scheduling a downlink transmission on the downlink carrier of the downlink-only cell may also be set to A in order to size align the DCI formats. The number of information bits included in the DCI format 0_0 may be padded if the DCI format 1_0 has more bits or bits may be truncated if the frequency domain resources assignment in DCI format 1_0 has more bits than the DCI format 0_0. The DCI formats 0_0 and 1_0 discussed here may be monitored in a common search space.

At step 1 the network entity or the UE may determine the size of DCI formats 0_0 and 1_0 to be size B according to the techniques discussed above. Here though, the DCI formats 0_0 and 1_0 may be DCIs monitored in a UE-specific search space. The network entity or UE may identify or otherwise determine that the number of information bits included in the DCI format 1_0 scheduling a downlink transmission on the downlink carrier of the downlink-only cell may be set to B in order to size align the DCI formats with the DCI format 0_0. Again, padding or truncation may be applied to the DCI formats to achieve size alignment.

At step 2, the network entity or the UE may determine the size of DCI format 0_1 scheduling an uplink transmission on an uplink carrier of the uplink-only cell as well as the size of DCI format 1_1 scheduling a downlink transmission on the downlink carrier of the downlink-only cell. The number of information bits included in the DCI formats 0_1 and 1_1 may, again, be based on a mixture of fixed bit sizes used to indicate various parameters as well as variable bit sizes used to indicate other parameters (e.g., such as frequency domain resource allocation bit sizes). The network entity or the UE may size align the number of information bits included in the DCI formats 0_1 and 1_1 to be the same (e.g., sizes C/D).

At step 2A, the network entity or the UE may determine the size of DCI format 0_2 scheduling an uplink transmission on an uplink carrier of the uplink-only cell as well as the size of DCI format 1_2 scheduling a downlink transmission on the downlink carrier of the downlink-only cell. The number of information bits included in the DCI formats 0_2 and 1_2 may, again, be based on a mixture of fixed bit sizes used to indicate various parameters as well as variable bit sizes used to indicate other parameters (e.g., such as frequency domain resource allocation bit sizes). The network entity or the UE may size align the number of information bits included in the DCI formats 0_2 and 1_2 to be the same (e.g., sizes E/F).

At step 3, the network entity or UE may examine two conditions to determine if the size alignment procedure is complete. For example, the network entity or UE may identify or otherwise determine whether the total number of different DCI sizes that the UE is configured to monitor is no more than four for the cell (or no more than three for DCI sizes with C-RNTI). If so, the procedure is complete. If not, the procedure may continue to the next step.

If the UE is configured to monitor more than four DCI sizes, at step 4A the network entity or UE may adjust the number of information bits included in DCI formats 0_0 and 1_0 to reduce the total number of different DCI sizes that the UE is to monitor. For example, if the number of information bits included in UE-specific DCI monitored search spaces is greater than four, bits may be added or truncated to align the size of DCI formats 0_0 and 1_0 monitored in UE-specific search spaces in order to align these UE-specific SS set DCI sizes (size B) with the common SS set DCI sizes (size A).

At step 4B, the network entity or the UE may adjust the number of information bits included in DCI formats 0_2 and 1_2 so that these DCI formats are size aligned. For example, bits may be padded or truncated if DCI size E and F are not equal (e.g., to size align the DCI formats to the same size in order to reduce the number of different size DCI formats that the UE has to monitor).

At step 4C, the network entity or the UE may adjust the number of information bits included in DCI formats 0_1 and 1_1 so that these DCI formats are size aligned. For example, bits may be padded or truncated if the DCI size C and D are not equal (e.g., to size align the DCI formats to the same size).

Accordingly, the information bit size scheme 405 illustrates non-limiting steps to align the sizes of the first grant and the second grant to include the same number of information bits. The size alignment procedure may also minimize the number of different DCI sizes that the network entity is to transmit and the UE is to monitor.

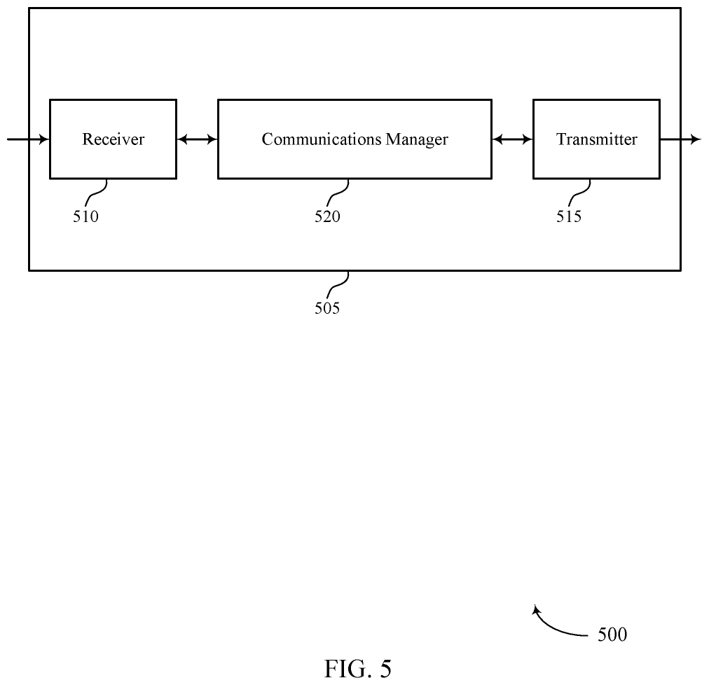

FIG. 5 shows a block diagram 500 of a device 505 that supports SS set configuration for a pair of downlink and uplink cells in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, and instructions stored in the at least one memory to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to SS set configuration for a pair of downlink and uplink cells). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to SS set configuration for a pair of downlink and uplink cells). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of SS set configuration for a pair of downlink and uplink cells as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving an indication of SS set parameters for a first cell associated with an uplink carrier and a second cell associated with a downlink carrier, the first cell including an uplink-only cell and the second cell including a downlink-only cell. The communications manager 520 is capable of, configured to, or operable to support a means for receiving a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell. The communications manager 520 is capable of, configured to, or operable to support a means for performing the uplink transmission, receiving the downlink transmission, or both, according to the grant.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for pairing a set of uplink-only and downlink-only cells to configure a SS set that can be used for scheduling both cells.

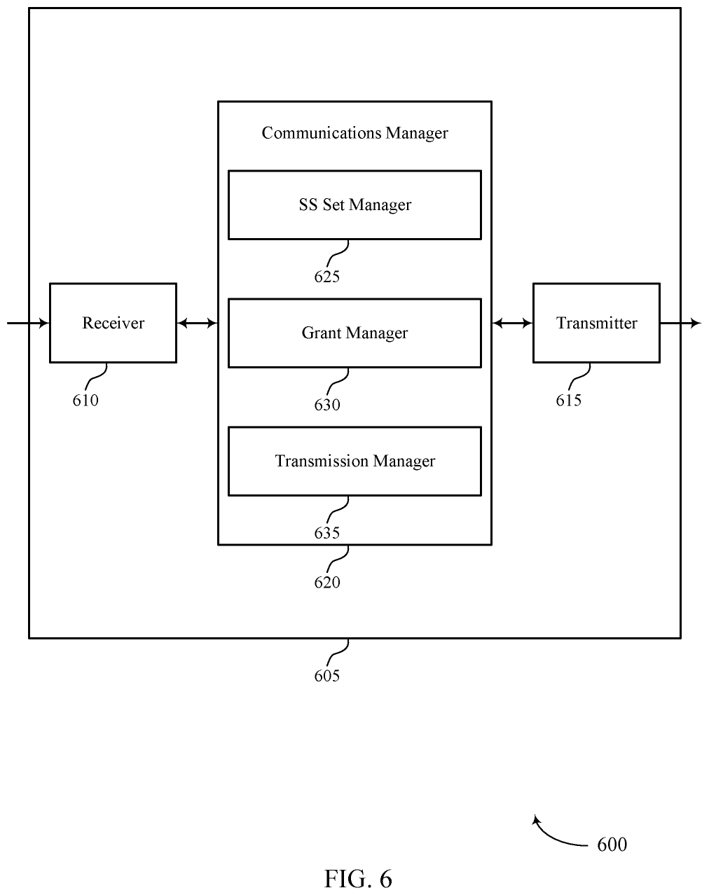

FIG. 6 shows a block diagram 600 of a device 605 that supports SS set configuration for a pair of downlink and uplink cells in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to SS set configuration for a pair of downlink and uplink cells). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SS set configuration for a pair of downlink and uplink cells). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of SS set configuration for a pair of downlink and uplink cells as described herein. For example, the communications manager 620 may include an SS set manager 625, a grant manager 630, a transmission manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SS set manager 625 is capable of, configured to, or operable to support a means for receiving an indication of SS set parameters for a first cell associated with an uplink carrier and a second cell associated with a downlink carrier, the first cell including an uplink-only cell and the second cell including a downlink-only cell. The grant manager 630 is capable of, configured to, or operable to support a means for receiving a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell. The transmission manager 635 is capable of, configured to, or operable to support a means for performing the uplink transmission, receiving the downlink transmission, or both, according to the grant.

In some cases, the SS set manager 625, the grant manager 630, the transmission manager 635, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of SS set manager 625, grant manager 630, or transmission manager 635, discussed herein. A transceiver processor may be collocated with or communicate with (e.g., direct the operations of) a transceiver of the device. A radio processor may be collocated with or communicate with (e.g., direct the operations of) a radio (e.g., an NR radio, an LTE radio, a Wi-Fi radio) of the device. A transmitter processor may be collocated with or communicate with (e.g., direct the operations of) a transmitter of the device. A receiver processor may be collocated with or communicate with (e.g., direct the operations of) a receiver of the device.

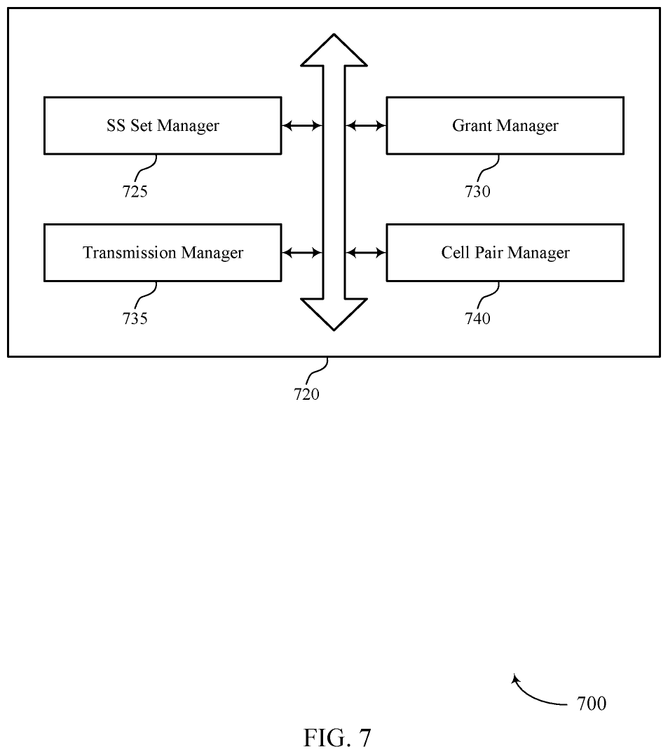

FIG. 7 shows a block diagram 700 of a communications manager 720 that supports SS set configuration for a pair of downlink and uplink cells in accordance with one or more aspects of the present disclosure. The communications manager 720 may be an example of aspects of a communications manager 520, a communications manager 620, or both, as described herein. The communications manager 720, or various components thereof, may be an example of means for performing various aspects of SS set configuration for a pair of downlink and uplink cells as described herein. For example, the communications manager 720 may include an SS set manager 725, a grant manager 730, a transmission manager 735, a cell pair manager 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The SS set manager 725 is capable of, configured to, or operable to support a means for receiving an indication of SS set parameters for a first cell associated with an uplink carrier and a second cell associated with a downlink carrier, the first cell including an uplink-only cell and the second cell including a downlink-only cell. The grant manager 730 is capable of, configured to, or operable to support a means for receiving a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell. The transmission manager 735 is capable of, configured to, or operable to support a means for performing the uplink transmission, receiving the downlink transmission, or both, according to the grant.

In some examples, the cell pair manager 740 is capable of, configured to, or operable to support a means for receiving information identifying the first cell and the second cell as a paired set of cells, where the SS set parameters are based on the paired set of cells. In some examples, to support receiving the grant, the cell pair manager 740 is capable of, configured to, or operable to support a means for receiving a shared CIF of the grant that is associated with the first cell and the second cell, where the shared CIF indicates that the grant schedules the uplink transmission via the first cell, the downlink transmission via the second cell, or both.

In some examples, to support receiving the grant, the cell pair manager 740 is capable of, configured to, or operable to support a means for receiving a first grant scheduling the uplink transmission via the first cell. In some examples, to support receiving the grant, the cell pair manager 740 is capable of, configured to, or operable to support a means for receiving a second grant scheduling the downlink transmission via the second cell, where a first number of information bits in the first grant and a second number of information bits in the second grant include a same number of information bits.

In some examples, the cell pair manager 740 is capable of, configured to, or operable to support a means for receiving an indication of an information bit size allocation for scheduling the uplink transmission via the first cell and for scheduling the downlink transmission via the second cell, where the same number of information bits is based on the information bit size allocation. In some examples, to support receiving the grant, the cell pair manager 740 is capable of, configured to, or operable to support a means for receiving an indication of whether the grant schedules the uplink transmission via the first cell or the downlink transmission via the second cell.

In some examples, to support receiving the grant, the cell pair manager 740 is capable of, configured to, or operable to support a means for monitoring, according to the SS set parameters, a SS set on the downlink carrier of the second cell, the second downlink carrier of the third cell, or both. In some examples, the SS set parameters identify a set of control channel resources to monitor to receive the grant on the downlink carrier of the second cell or the second downlink carrier of the third cell. In some examples, the grant includes a DCI format 0_2 uplink grant, a DCI format 1_2 downlink grant, or both. In some examples, the first cell includes a non-downlink carrier cell and the second cell includes a non-uplink carrier cell.

In some cases, the SS set manager 725, the grant manager 730, the transmission manager 735, or the cell pair manager 740, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the SS set manager 725, the grant manager 730, the transmission manager 735, or the cell pair manager 740, discussed herein.

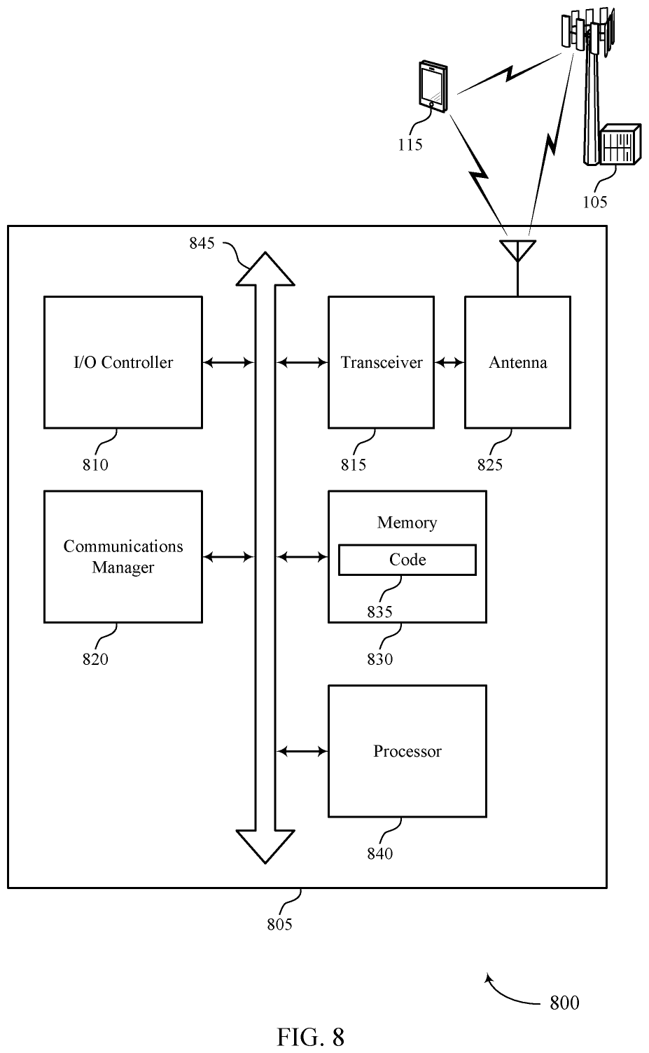

FIG. 8 shows a diagram of a system 800 including a device 805 that supports SS set configuration for a pair of downlink and uplink cells in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting SS set configuration for a pair of downlink and uplink cells). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving an indication of SS set parameters for a first cell associated with an uplink carrier and a second cell associated with a downlink carrier, the first cell including an uplink-only cell and the second cell including a downlink-only cell. The communications manager 820 is capable of, configured to, or operable to support a means for receiving a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell. The communications manager 820 is capable of, configured to, or operable to support a means for performing the uplink transmission, receiving the downlink transmission, or both, according to the grant.

By including or configuring the communications manager 820 in accordance with examples as described herein, the device 805 may support techniques for pairing a set of uplink-only and downlink-only cells to configure a SS set that can be used for scheduling both cells.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of SS set configuration for a pair of downlink and uplink cells as described herein, or the at least one processor 840 and the at least one memory 830 may be otherwise configured to, individually or collectively, perform or support such operations.

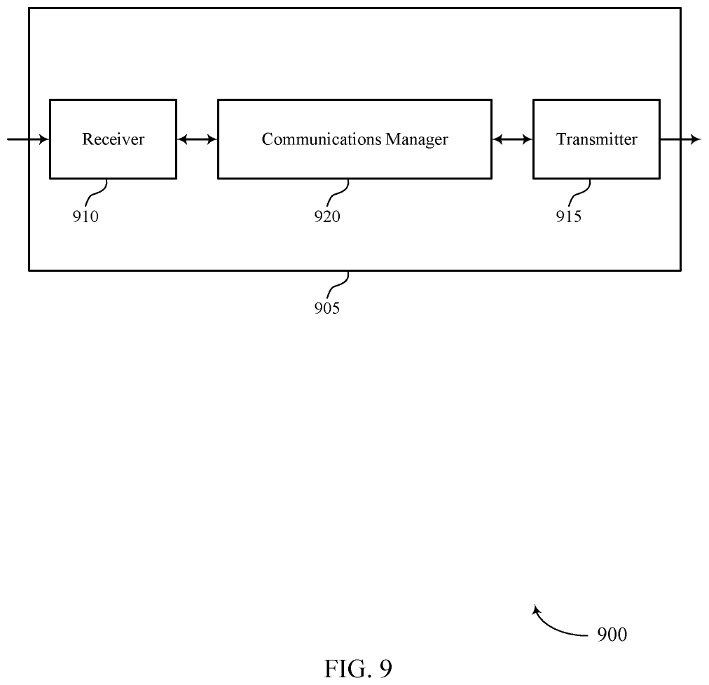

FIG. 9 shows a block diagram 900 of a device 905 that supports SS set configuration for a pair of downlink and uplink cells in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, and instructions stored in the at least one memory to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of SS set configuration for a pair of downlink and uplink cells as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, to a UE, an indication of SS set parameters for a first cell associated with an uplink carrier and a second cell associated with a downlink carrier, the first cell including an uplink-only cell and the second cell including a downlink-only cell. The communications manager 920 is capable of, configured to, or operable to support a means for transmitting a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell. The communications manager 920 is capable of, configured to, or operable to support a means for receiving the uplink transmission from the UE, performing the downlink transmission to the UE, or both, according to the grant.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for pairing a set of uplink-only and downlink-only cells to configure a SS set that can be used for scheduling both cells.

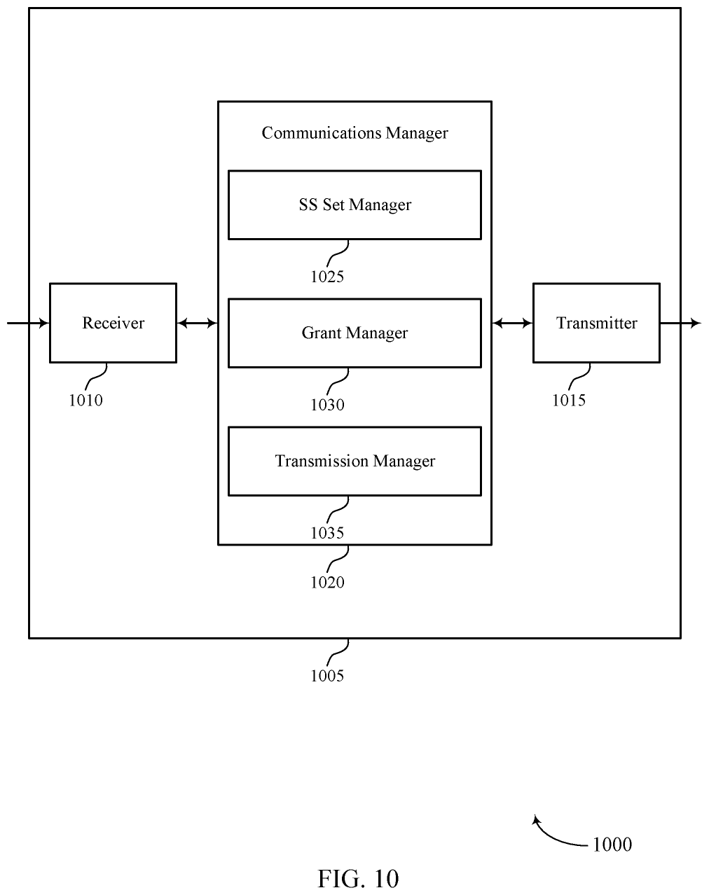

FIG. 10 shows a block diagram 1000 of a device 1005 that supports SS set configuration for a pair of downlink and uplink cells in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of SS set configuration for a pair of downlink and uplink cells as described herein. For example, the communications manager 1020 may include an SS set manager 1025, a grant manager 1030, a transmission manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The SS set manager 1025 is capable of, configured to, or operable to support a means for transmitting, to a UE, an indication of SS set parameters for a first cell associated with an uplink carrier and a second cell associated with a downlink carrier, the first cell including an uplink-only cell and the second cell including a downlink-only cell. The grant manager 1030 is capable of, configured to, or operable to support a means for transmitting a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell. The transmission manager 1035 is capable of, configured to, or operable to support a means for receiving the uplink transmission from the UE, performing the downlink transmission to the UE, or both, according to the grant.

In some cases, the SS set manager 1025, the grant manager 1030, or the transmission manager 1035, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the SS set manager 1025, the grant manager 1030, or the transmission manager 1035 discussed herein. A transceiver processor may be collocated with or communicate with (e.g., direct the operations of) a transceiver of the device. A radio processor may be collocated with or communicate with (e.g., direct the operations of) a radio (e.g., an NR radio, an LTE radio, a Wi-Fi radio) of the device. A transmitter processor may be collocated with or communicate with (e.g., direct the operations of) a transmitter of the device. A receiver processor may be collocated with or communicate with (e.g., direct the operations of) a receiver of the device.

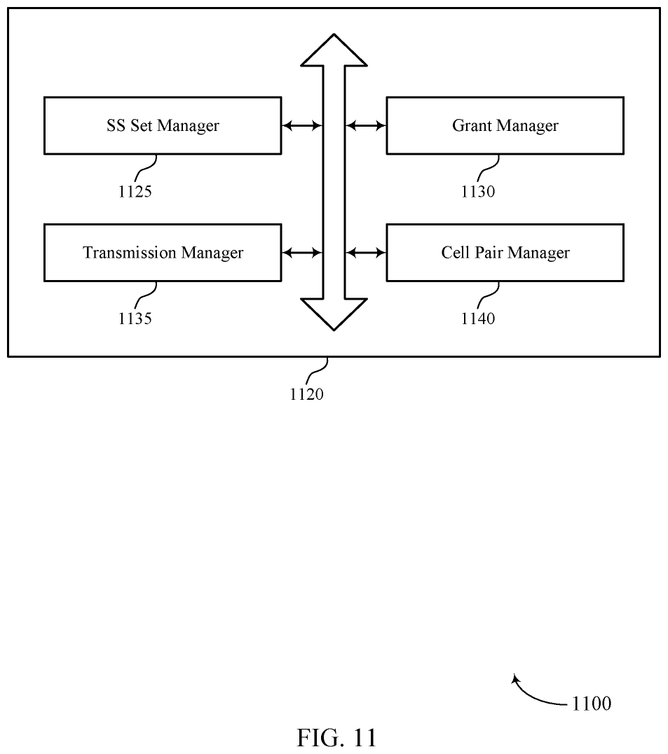

FIG. 11 shows a block diagram 1100 of a communications manager 1120 that supports SS set configuration for a pair of downlink and uplink cells in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of SS set configuration for a pair of downlink and uplink cells as described herein. For example, the communications manager 1120 may include an SS set manager 1125, a grant manager 1130, a transmission manager 1135, a cell pair manager 1140, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The SS set manager 1125 is capable of, configured to, or operable to support a means for transmitting, to a UE, an indication of SS set parameters for a first cell associated with an uplink carrier and a second cell associated with a downlink carrier, the first cell including an uplink-only cell and the second cell including a downlink-only cell. The grant manager 1130 is capable of, configured to, or operable to support a means for transmitting a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell. The transmission manager 1135 is capable of, configured to, or operable to support a means for receiving the uplink transmission from the UE, performing the downlink transmission to the UE, or both, according to the grant.

In some examples, the cell pair manager 1140 is capable of, configured to, or operable to support a means for transmitting information identifying the first cell and the second cell as a paired set of cells, where the SS set parameters are based on the paired set of cells. In some examples, to support transmitting the grant, the cell pair manager 1140 is capable of, configured to, or operable to support a means for configuring the grant to indicate a shared CIF that is associated with the first cell and the second cell, where the shared CIF indicates that the grant schedules the uplink transmission via the first cell, the downlink transmission via the second cell, or both.

In some examples, to support transmitting the grant, the cell pair manager 1140 is capable of, configured to, or operable to support a means for transmitting a first grant scheduling the uplink transmission via the first cell. In some examples, to support transmitting the grant, the cell pair manager 1140 is capable of, configured to, or operable to support a means for transmitting a second grant scheduling the downlink transmission via the second cell, where a first number of information bits in the first grant and a second number of information bits in the second grant include a same number of information bits.

In some examples, the cell pair manager 1140 is capable of, configured to, or operable to support a means for transmitting an indication of an information bit size allocation for scheduling the uplink transmission via the first cell and for scheduling the downlink transmission via the second cell, where the same number of information bits is based on the information bit size allocation. In some examples, to support transmitting the grant, the cell pair manager 1140 is capable of, configured to, or operable to support a means for configuring an indication of whether the grant schedules the uplink transmission via the first cell or the downlink transmission via the second cell.

In some examples, to support transmitting the grant, the cell pair manager 1140 is capable of, configured to, or operable to support a means for transmitting, according to the SS set parameters, the grant on a SS set on the downlink carrier of the second cell, the second downlink carrier of the third cell, or both. In some examples, the SS set parameters identify a set of control channel resources to monitor to receive the grant on the downlink carrier of the second cell or the second downlink carrier of the third cell. In some examples, the grant includes a DCI format 0_2 uplink grant, a DCI format 1_2 downlink grant, or both. In some examples, the first cell includes a non-downlink carrier cell and the second cell includes a non-uplink carrier cell.

In some cases, the SS set manager 1125, the grant manager 1130, the transmission manager 1135, or the cell pair manager 1140 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the SS set manager 1125, the grant manager 1130, the transmission manager 1135, or the cell pair manager 1140, discussed herein.

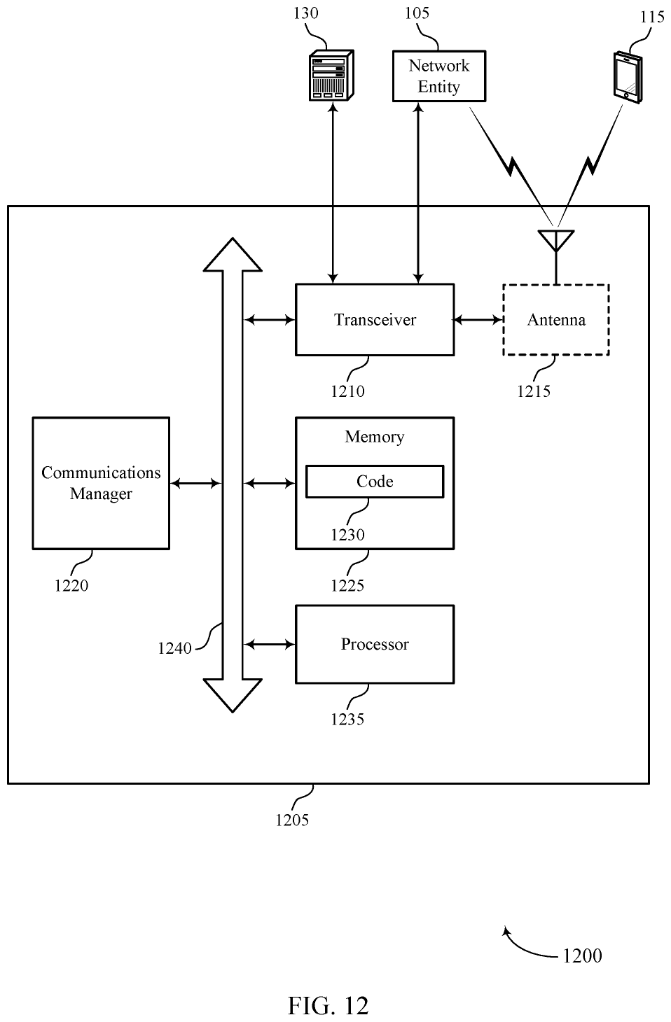

FIG. 12 shows a diagram of a system 1200 including a device 1205 that supports SS set configuration for a pair of downlink and uplink cells in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting SS set configuration for a pair of downlink and uplink cells). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting, to a UE, an indication of SS set parameters for a first cell associated with an uplink carrier and a second cell associated with a downlink carrier, the first cell including an uplink-only cell and the second cell including a downlink-only cell. The communications manager 1220 is capable of, configured to, or operable to support a means for transmitting a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell. The communications manager 1220 is capable of, configured to, or operable to support a means for receiving the uplink transmission from the UE, performing the downlink transmission to the UE, or both, according to the grant.

By including or configuring the communications manager 1220 in accordance with examples as described herein, the device 1205 may support techniques for pairing a set of uplink-only and downlink-only cells to configure a SS set that can be used for scheduling both cells.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of SS set configuration for a pair of downlink and uplink cells as described herein, or the at least one processor 1235 and the at least one memory 1225 may be otherwise configured to, individually or collectively, perform or support such operations.

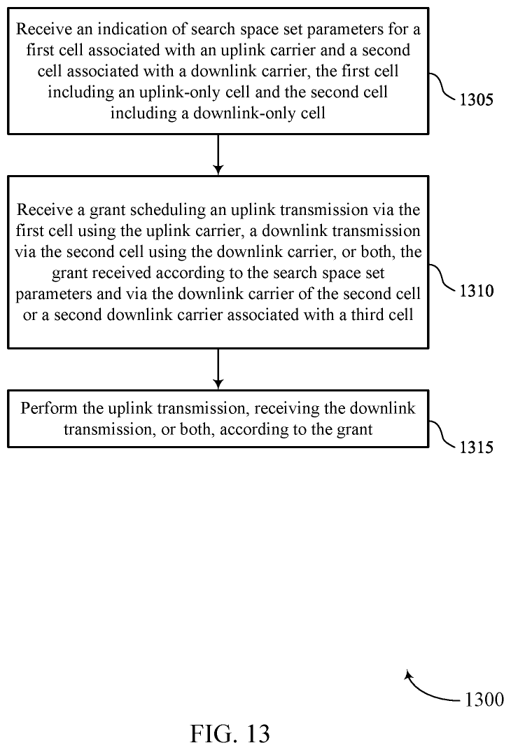

FIG. 13 shows a flowchart illustrating a method 1300 that supports SS set configuration for a pair of downlink and uplink cells in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an indication of SS set parameters for a first cell associated with an uplink carrier and a second cell associated with a downlink carrier, the first cell including an uplink-only cell and the second cell including a downlink-only cell. The operations of block 1305 may be performed in accordance with examples as disclosed herein. In some examples, aspects of the operations of 1305 may be performed by an SS set manager 725 as described with reference to FIG. 7.

At 1310, the method may include receiving a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell. The operations of block 1310 may be performed in accordance with examples as disclosed herein. In some examples, aspects of the operations of 1310 may be performed by a grant manager 730 as described with reference to FIG. 7.

At 1315, the method may include performing the uplink transmission, receiving the downlink transmission, or both, according to the grant. The operations of block 1315 may be performed in accordance with examples as disclosed herein. In some examples, aspects of the operations of 1315 may be performed by a transmission manager 735 as described with reference to FIG. 7.

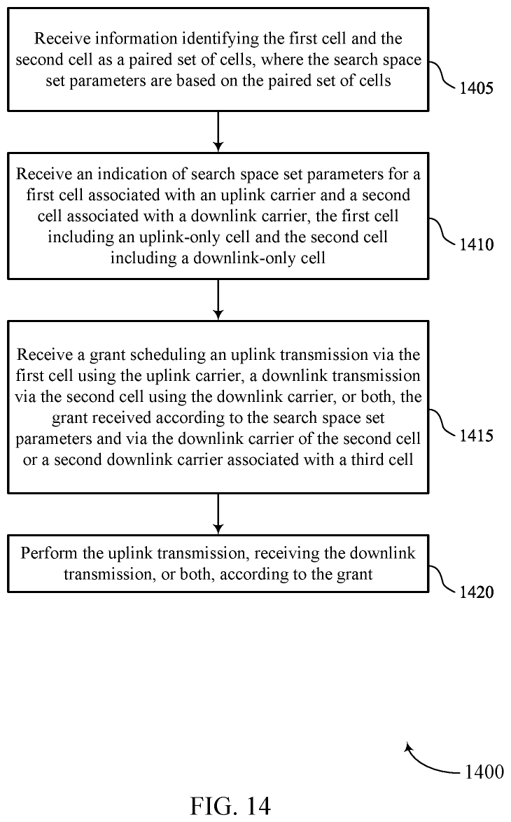

FIG. 14 shows a flowchart illustrating a method 1400 that supports SS set configuration for a pair of downlink and uplink cells in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving information identifying the first cell and the second cell as a paired set of cells, where the SS set parameters are based on the paired set of cells. The operations of block 1405 may be performed in accordance with examples as disclosed herein. In some examples, aspects of the operations of 1405 may be performed by a cell pair manager 740 as described with reference to FIG. 7.

At 1410, the method may include receiving an indication of SS set parameters for a first cell associated with an uplink carrier and a second cell associated with a downlink carrier, the first cell including an uplink-only cell and the second cell including a downlink-only cell. The operations of block 1410 may be performed in accordance with examples as disclosed herein. In some examples, aspects of the operations of 1410 may be performed by an SS set manager 725 as described with reference to FIG. 7.

At 1415, the method may include receiving a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell. The operations of block 1415 may be performed in accordance with examples as disclosed herein. In some examples, aspects of the operations of 1415 may be performed by a grant manager 730 as described with reference to FIG. 7.

At 1420, the method may include performing the uplink transmission, receiving the downlink transmission, or both, according to the grant. The operations of block 1420 may be performed in accordance with examples as disclosed herein. In some examples, aspects of the operations of 1420 may be performed by a transmission manager 735 as described with reference to FIG. 7.

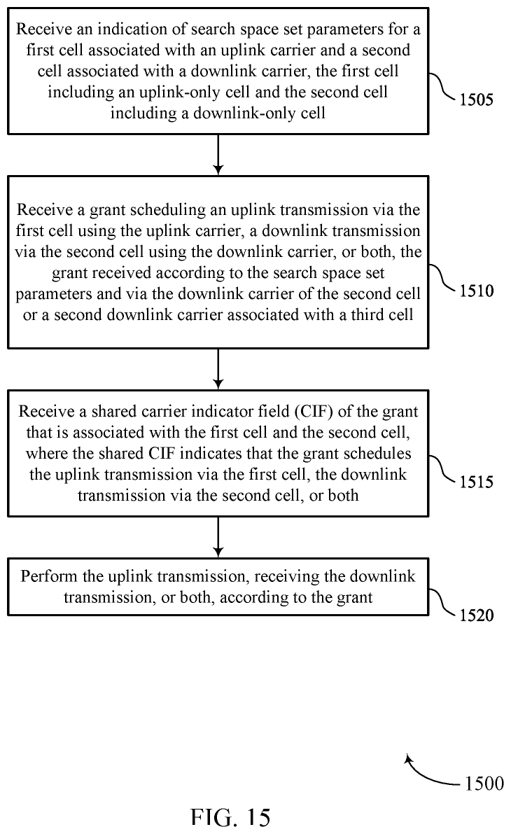

FIG. 15 shows a flowchart illustrating a method 1500 that supports SS set configuration for a pair of downlink and uplink cells in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving an indication of SS set parameters for a first cell associated with an uplink carrier and a second cell associated with a downlink carrier, the first cell including an uplink-only cell and the second cell including a downlink-only cell. The operations of block 1505 may be performed in accordance with examples as disclosed herein. In some examples, aspects of the operations of 1505 may be performed by an SS set manager 725 as described with reference to FIG. 7.

At 1510, the method may include receiving a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell. The operations of block 1510 may be performed in accordance with examples as disclosed herein. In some examples, aspects of the operations of 1510 may be performed by a grant manager 730 as described with reference to FIG. 7.

At 1515, the method may include receiving a shared carrier indicator field (CIF) of the grant that is associated with the first cell and the second cell, where the shared CIF indicates that the grant schedules the uplink transmission via the first cell, the downlink transmission via the second cell, or both. The operations of block 1515 may be performed in accordance with examples as disclosed herein. In some examples, aspects of the operations of 1515 may be performed by a cell pair manager 740 as described with reference to FIG. 7.

At 1520, the method may include performing the uplink transmission, receiving the downlink transmission, or both, according to the grant. The operations of block 1520 may be performed in accordance with examples as disclosed herein. In some examples, aspects of the operations of 1520 may be performed by a transmission manager 735 as described with reference to FIG. 7.

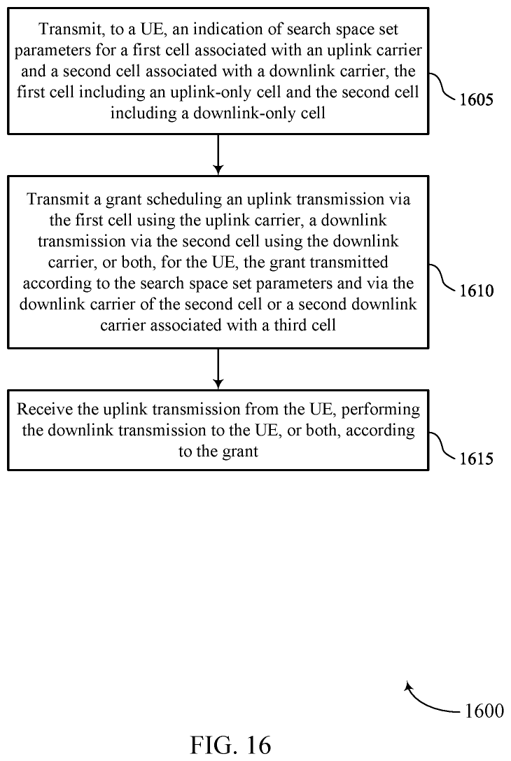

FIG. 16 shows a flowchart illustrating a method 1600 that supports SS set configuration for a pair of downlink and uplink cells in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, an indication of SS set parameters for a first cell associated with an uplink carrier and a second cell associated with a downlink carrier, the first cell including an uplink-only cell and the second cell including a downlink-only cell. The operations of block 1605 may be performed in accordance with examples as disclosed herein. In some examples, aspects of the operations of 1605 may be performed by an SS set manager 1125 as described with reference to FIG. 11.

At 1610, the method may include transmitting a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell. The operations of block 1610 may be performed in accordance with examples as disclosed herein. In some examples, aspects of the operations of 1610 may be performed by a grant manager 1130 as described with reference to FIG. 11.

At 1615, the method may include receiving the uplink transmission from the UE, performing the downlink transmission to the UE, or both, according to the grant. The operations of block 1615 may be performed in accordance with examples as disclosed herein. In some examples, aspects of the operations of 1615 may be performed by a transmission manager 1135 as described with reference to FIG. 11.

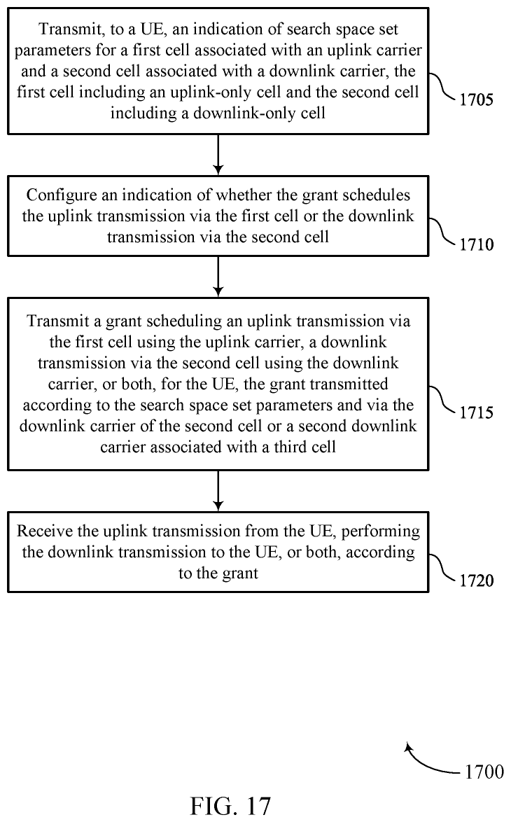

FIG. 17 shows a flowchart illustrating a method 1700 that supports SS set configuration for a pair of downlink and uplink cells in accordance with aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, an indication of SS set parameters for a first cell associated with an uplink carrier and a second cell associated with a downlink carrier, the first cell including an uplink-only cell and the second cell including a downlink-only cell. The operations of block 1705 may be performed in accordance with examples as disclosed herein. In some examples, aspects of the operations of 1705 may be performed by an SS set manager 1125 as described with reference to FIG. 11.

At 1710, the method may include configuring an indication of whether the grant schedules the uplink transmission via the first cell or the downlink transmission via the second cell. The operations of block 1710 may be performed in accordance with examples as disclosed herein. In some examples, aspects of the operations of 1710 may be performed by a cell pair manager 1140 as described with reference to FIG. 11.

At 1715, the method may include transmitting a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell. The operations of block 1715 may be performed in accordance with examples as disclosed herein. In some examples, aspects of the operations of 1715 may be performed by a grant manager 1130 as described with reference to FIG. 11.

At 1720, the method may include receiving the uplink transmission from the UE, performing the downlink transmission to the UE, or both, according to the grant. The operations of block 1720 may be performed in accordance with examples as disclosed herein. In some examples, aspects of the operations of 1720 may be performed by a transmission manager 1135 as described with reference to FIG. 11.

The following provides an overview of aspects of the present disclosure:

Aspect 1: A method for wireless communications at a UE, comprising: receiving an indication of SS set parameters for a first cell associated with an uplink carrier and a second cell associated with a downlink carrier, the first cell comprising an uplink-only cell and the second cell comprising a downlink-only cell; receiving a grant scheduling an uplink transmission via the first cell using the uplink carrier, a downlink transmission via the second cell using the downlink carrier, or both, the grant received according to the SS set parameters and via the downlink carrier of the second cell or a second downlink carrier associated with a third cell; and performing the uplink transmission, receiving the downlink transmission, or both, according to the grant.

Aspect 2: The method of aspect 1, further comprising: receiving information identifying the first cell and the second cell as a paired set of cells, wherein the SS set parameters are based at least in part on the paired set of cells.

Aspect 3: The method of any of aspects 1 through 2, wherein receiving the grant comprises: receiving a shared CIF of the grant that is associated with the first cell and the second cell, wherein the shared CIF indicates that the grant schedules the uplink transmission via the first cell, the downlink transmission via the second cell, or both.

Aspect 4: The method of any of aspects 1 through 3, wherein receiving the grant comprises: receiving a first grant scheduling the uplink transmission via the first cell; and receiving a second grant scheduling the downlink transmission via the second cell, wherein a first number of information bits in the first grant and a second number of information bits in the second grant comprise a same number of information bits.

Aspect 5: The method of aspect 4, further comprising: receiving an indication of an information bit size allocation for scheduling the uplink transmission via the first cell and for scheduling the downlink transmission via the second cell, wherein the same number of information bits is based on the information bit size allocation.

Aspect 6: The method of any of aspects 1 through 5, wherein receiving the grant comprises: receiving an indication of whether the grant schedules the uplink transmission via the first cell or the downlink transmission via the second cell.

Aspect 7: The method of any of aspects 1 through 6, wherein receiving the grant comprises: monitoring, according to the SS set parameters, a SS set on the downlink carrier of the second cell, the second downlink carrier of the third cell, or both.

Aspect 8: The method of any of aspects 1 through 7, wherein the SS set parameters identify a set of control channel resources to monitor to receive the grant on the downlink carrier of the second cell or the second downlink carrier of the third cell.

Aspect 9: The method of any of aspects 1 through 8, wherein the grant comprises a DCI format 0_2 uplink grant, a DCI format 1_2 downlink grant, or both.

Aspect 10: The method of any of aspects 1 through 9, wherein the first cell comprises a non-downlink carrier cell and the second cell comprises a non-uplink carrier cell.

Aspect 11: A method for wireless communications at a network entity, comprising: transmitting, to a UE, an indication of SS set parameters for a first cell associated with an uplink carrier and a second cell associated with a downlink carrier, the first cell comprising an uplink-only cell and the second cell comprising a downlink-only cell; transmitting a grant scheduling an uplink transmission via the first cell using the uplink carrier, a downlink transmission via the second cell using the downlink carrier, or both, for the UE, the grant transmitted according to the SS set parameters and via the downlink carrier of the second cell or a second downlink carrier associated with a third cell; and receiving the uplink transmission from the UE, performing the downlink transmission to the UE, or both, according to the grant.

Aspect 12: The method of aspect 11, further comprising: transmitting information identifying the first cell and the second cell as a paired set of cells, wherein the SS set parameters are based at least in part on the paired set of cells.

Aspect 13: The method of any of aspects 11 through 12, wherein transmitting the grant comprises: configuring the grant to indicate a shared CIF that is associated with the first cell and the second cell, wherein the shared CIF indicates that the grant schedules the uplink transmission via the first cell, the downlink transmission via the second cell, or both.

Aspect 14: The method of any of aspects 11 through 13, wherein transmitting the grant comprises: transmitting a first grant scheduling the uplink transmission via the first cell; and transmitting a second grant scheduling the downlink transmission via the second cell, wherein a first number of information bits in the first grant and a second number of information bits in the second grant comprise a same number of information bits.

Aspect 15: The method of aspect 14, further comprising: transmitting an indication of an information bit size allocation for scheduling the uplink transmission via the first cell and for scheduling the downlink transmission via the second cell, wherein the same number of information bits is based on the information bit size allocation.

Aspect 16: The method of any of aspects 11 through 15, wherein transmitting the grant comprises: configuring an indication of whether the grant schedules the uplink transmission via the first cell or the downlink transmission via the second cell.

Aspect 17: The method of any of aspects 11 through 16, wherein transmitting the grant comprises: transmitting, according to the SS set parameters, the grant on a SS set on the downlink carrier of the second cell, the second downlink carrier of the third cell, or both.

Aspect 18: The method of any of aspects 11 through 17, wherein the SS set parameters identify a set of control channel resources to monitor to receive the grant on the downlink carrier of the second cell or the second downlink carrier of the third cell.

Aspect 19: The method of any of aspects 11 through 18, wherein the grant comprises a DCI format 0_2 uplink grant, a DCI format 1_2 downlink grant, or both.

Aspect 20: The method of any of aspects 11 through 19, wherein the first cell comprises a non-downlink carrier cell and the second cell comprises a non-uplink carrier cell.

Aspect 21: A UE for wireless communications, comprising one or more memories storing processor-executable code, and one or more processors coupled with the one or more memories and individually or collectively operable to execute the code to cause the UE to perform a method of any of aspects 1 through 10.

Aspect 22: A UE for wireless communications, comprising at least one means for performing a method of any of aspects 1 through 10.

Aspect 23: A non-transitory computer-readable medium storing code for wireless communications, the code comprising instructions executable by a processor to perform a method of any of aspects 1 through 10.

Aspect 24: A network entity for wireless communications, comprising one or more memories storing processor-executable code, and one or more processors coupled with the one or more memories and individually or collectively operable to execute the code to cause the network entity to perform a method of any of aspects 11 through 20.

Aspect 25: A network entity for wireless communications, comprising at least one means for performing a method of any of aspects 11 through 20.

Aspect 26: A non-transitory computer-readable medium storing code for wireless communications, the code comprising instructions executable by a processor to perform a method of any of aspects 11 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indication of search space set parameters for a first cell associated with an uplink carrier and a second cell associated with a downlink carrier, the first cell comprising an uplink-only cell and the second cell comprising a downlink-only cell;
receive a grant scheduling an uplink transmission via the first cell using the uplink carrier, a downlink transmission via the second cell using the downlink carrier, or both, the grant received according to the search space set parameters and via the downlink carrier of the second cell or a second downlink carrier associated with a third cell; and
perform the uplink transmission, receiving the downlink transmission, or both, according to the grant.

2. The UE of claim 1, wherein the one or more processors are individually or collectively further operable to execute the code to cause the UE to:
receive information identifying the first cell and the second cell as a paired set of cells, wherein the search space set parameters are based at least in part on the paired set of cells.

3. The UE of claim 1, wherein, to receive the grant, the one or more processors are individually or collectively operable to execute the code to cause the UE to:
receive a shared carrier indicator field (CIF) of the grant that is associated with the first cell and the second cell, wherein the shared CIF indicates that the grant schedules the uplink transmission via the first cell, the downlink transmission via the second cell, or both.

4. The UE of claim 1, wherein, to receive the grant, the one or more processors are individually or collectively operable to execute the code to cause the UE to:
receive a first grant scheduling the uplink transmission via the first cell; and
receive a second grant scheduling the downlink transmission via the second cell, wherein a first number of information bits in the first grant and a second number of information bits in the second grant comprise a same number of information bits.

5. The UE of claim 4, wherein the one or more processors are individually or collectively further operable to execute the code to cause the UE to:
receive an indication of an information bit size allocation for scheduling the uplink transmission via the first cell and for scheduling the downlink transmission via the second cell, wherein the same number of information bits is based on the information bit size allocation.

6. The UE of claim 1, wherein, to receive the grant, the one or more processors are individually or collectively operable to execute the code to cause the UE to:
receive an indication of whether the grant schedules the uplink transmission via the first cell or the downlink transmission via the second cell.

7. The UE of claim 1, wherein, to receive the grant, the one or more processors are individually or collectively operable to execute the code to cause the UE to:
monitor, according to the search space set parameters, a search space set on the downlink carrier of the second cell, the second downlink carrier of the third cell, or both.

8. The UE of claim 1, wherein the search space set parameters identify a set of control channel resources to monitor to receive the grant on the downlink carrier of the second cell or the second downlink carrier of the third cell.

9. The UE of claim 1, wherein the grant comprises a downlink control information (DCI) format 0_2 uplink grant, a DCI format 1_2 downlink grant, or both.

10. The UE of claim 1, wherein the first cell comprises a non-downlink carrier cell and the second cell comprises a non-uplink carrier cell.

11. A network entity, comprising:
one or more memories storing processor-executable code; and
one or more processors coupled with the one or more memories and individually or collectively operable to execute the code to cause the network entity to:
transmit, to a user equipment (UE), an indication of search space set parameters for a first cell associated with an uplink carrier and a second cell associated with a downlink carrier, the first cell comprising an uplink-only cell and the second cell comprising a downlink-only cell;
transmit a grant scheduling an uplink transmission via the first cell using the uplink carrier, a downlink transmission via the second cell using the downlink carrier, or both, for the UE, the grant transmitted according to the search space set parameters and via the downlink carrier of the second cell or a second downlink carrier associated with a third cell; and
receive the uplink transmission from the UE, performing the downlink transmission to the UE, or both, according to the grant.

12. The network entity of claim 11, wherein the one or more processors are individually or collectively further operable to execute the code to cause the network entity to:
transmit information identifying the first cell and the second cell as a paired set of cells, wherein the search space set parameters are based at least in part on the paired set of cells.

13. The network entity of claim 11, wherein, to transmit the grant, the one or more processors are individually or collectively operable to execute the code to cause the network entity to:
configure the grant to indicate a shared carrier indicator field (CIF) that is associated with the first cell and the second cell, wherein the shared CIF indicates that the grant schedules the uplink transmission via the first cell, the downlink transmission via the second cell, or both.

14. The network entity of claim 11, wherein, to transmit the grant, the one or more processors are individually or collectively operable to execute the code to cause the network entity to:
transmit a first grant scheduling the uplink transmission via the first cell; and
transmit a second grant scheduling the downlink transmission via the second cell, wherein a first number of information bits in the first grant and a second number of information bits in the second grant comprise a same number of information bits.

15. The network entity of claim 14, wherein the one or more processors are individually or collectively further operable to execute the code to cause the network entity to:
transmit an indication of an information bit size allocation for scheduling the uplink transmission via the first cell and for scheduling the downlink transmission via the second cell, wherein the same number of information bits is based on the information bit size allocation.

16. The network entity of claim 11, wherein, to transmit the grant, the one or more processors are individually or collectively operable to execute the code to cause the network entity to:
configure an indication of whether the grant schedules the uplink transmission via the first cell or the downlink transmission via the second cell.

17. The network entity of claim 11, wherein, to transmit the grant, the one or more processors are individually or collectively operable to execute the code to cause the network entity to:
transmit, according to the search space set parameters, the grant on a search space set on the downlink carrier of the second cell, the second downlink carrier of the third cell, or both.

18. The network entity of claim 11, wherein the search space set parameters identify a set of control channel resources to monitor to receive the grant on the downlink carrier of the second cell or the second downlink carrier of the third cell.

19. The network entity of claim 11, wherein the grant comprises a downlink control information (DCI) format 0_2 uplink grant, a DCI format 1_2 downlink grant, or both.

20. The network entity of claim 11, wherein the first cell comprises a non-downlink carrier cell and the second cell comprises a non-uplink carrier cell.

21. A method for wireless communications at a user equipment (UE), comprising:
receiving an indication of search space set parameters for a first cell associated with an uplink carrier and a second cell associated with a downlink carrier, the first cell comprising an uplink-only cell and the second cell comprising a downlink-only cell;
receiving a grant scheduling an uplink transmission via the first cell using the uplink carrier, a downlink transmission via the second cell using the downlink carrier, or both, the grant received according to the search space set parameters and via the downlink carrier of the second cell or a second downlink carrier associated with a third cell; and
performing the uplink transmission, receiving the downlink transmission, or both, according to the grant.

22. The method of claim 21, further comprising:
receiving information identifying the first cell and the second cell as a paired set of cells, wherein the search space set parameters are based at least in part on the paired set of cells.

23. The method of claim 21, wherein receiving the grant comprises:
receiving a shared carrier indicator field (CIF) of the grant that is associated with the first cell and the second cell, wherein the shared CIF indicates that the grant schedules the uplink transmission via the first cell, the downlink transmission via the second cell, or both.

24. The method of claim 21, wherein receiving the grant comprises:
receiving a first grant scheduling the uplink transmission via the first cell; and
receiving a second grant scheduling the downlink transmission via the second cell, wherein a first number of information bits in the first grant and a second number of information bits in the second grant comprise a same number of information bits.

25. The method of claim 24, further comprising:
receiving an indication of an information bit size allocation for scheduling the uplink transmission via the first cell and for scheduling the downlink transmission via the second cell, wherein the same number of information bits is based on the information bit size allocation.

26. The method of claim 21, wherein receiving the grant comprises:
receiving an indication of whether the grant schedules the uplink transmission via the first cell or the downlink transmission via the second cell.

27. The method of claim 21, wherein receiving the grant comprises:
monitoring, according to the search space set parameters, a search space set on the downlink carrier of the second cell, the second downlink carrier of the third cell, or both.

28. The method of claim 21, wherein the search space set parameters identify a set of control channel resources to monitor to receive the grant on the downlink carrier of the second cell or the second downlink carrier of the third cell.

29. The method of claim 21, wherein the grant comprises a downlink control information (DCI) format 0_2 uplink grant, a DCI format 1_2 downlink grant, or both.

30. A method for wireless communications at a network entity, comprising:
transmitting, to a user equipment (UE), an indication of search space set parameters for a first cell associated with an uplink carrier and a second cell associated with a downlink carrier, the first cell comprising an uplink-only cell and the second cell comprising a downlink-only cell;
transmitting a grant scheduling an uplink transmission via the first cell using the uplink carrier, a downlink transmission via the second cell using the downlink carrier, or both, for the UE, the grant transmitted according to the search space set parameters and via the downlink carrier of the second cell or a second downlink carrier associated with a third cell; and
receiving the uplink transmission from the UE, performing the downlink transmission to the UE, or both, according to the grant.
